(19) United States
(12) Patent Application Publication
(10) Pub. No.: US 2006/0103786 A1
(43) Pub. Date: May 18, 2006

(54) Liquid crystal display device

(76) Inventors: Norio Koma, Motosu-gun (JP); Tsutomu Yamada, Mizuho-shi (JP); Kazuyuki Maeda, Nishikasugai-gun (JP); Masashi Mitsui, Anpachi-gun (JP)

Correspondence Address: CANTOR COLBURN, LLP, 55 GRIFFIN ROAD SOUTH, BLOOMFIELD, CT, 06002, US

(21) Appl. No.: 11/240,952

(22) Filed: Sep. 30, 2005

(30) Foreign Application Priority Data
Sep. 30, 2004 (JP) 2004-286278

(51) Int. Cl. G02F 1/1335

(52) U.S. Cl. 349/107

(57) ABSTRACT

In a liquid crystal display device, a thickness of a liquid crystal layer in each pixel is adjusted according to a display color (red, green, and blue). For example, by changing the thickness of the color filter corresponding to the display color according to the display color, a thickness (cell gap) of the liquid crystal layer in each pixel is set to a predetermined value corresponding to the transmittance of light in the liquid crystal. In order to maintain the cell gap at a constant value, heights of spacers formed above the color filters are set to values different from each other according to the thickness of the liquid crystal layer which differs for each display color. With this structure, the spacers substantially contribute to maintaining the gap in the pixel regions of different display colors in which the spacers are formed.

### CROSS-REFERENCE TO RELATED APPLICATIONS

The entire disclosure of. Japanese Patent Application No. 2004-286278 including specification, claims, drawings, and abstract is incorporated herein by reference.

### BACKGROUND OF THE INVENTION

1. Field of the Invention

The present invention relates to a liquid crystal display device and in particular to a multi-gap liquid crystal display device having regions with different thicknesses of a liquid crystal layer.

2. Description of the Related Art

Because liquid crystal display devices (hereinafter simply referred to as “LCD”) have advantages such as a thin thickness and low power consumption, the LCDs are widely in use as a computer monitor and a monitor for a portable information device or the like. In the LCD, liquid crystal is sealed between a pair of substrates and display is realized by controlling, using electrodes formed on the substrates, alignment of the liquid crystal positioned between the electrodes.

TN (Twisted Nematic) liquid crystal is known as the liquid crystal in such an LCD. In the LCD which uses the TN liquid crystal, an orientation film to which a rubbing process is applied is formed on a contact surface, which faces the liquid crystal, of each of the pair of substrates. When no voltage is applied, the TN liquid crystal which has a positive dielectric constant anisotropy is initially aligned such that the major axis of the molecule is aligned long the direction of rubbing of the orientation film. In many cases, the initial alignment of the liquid crystal is not completely along the plane of the substrate, but a pretilt is applied in advance; that is, the major axis of the molecule is tilted by a predetermined angle from the plane of the substrate.

The rubbing direction of the orientation film on one substrate and the rubbing direction of the orientation film on the other substrate are configured so that the rubbing directions are 90° twisted from each other and the liquid crystal is aligned with a twist of 90° between the pair of substrates. When a voltage is applied to the liquid crystal between the electrodes by the electrodes formed on the opposing surfaces of the pair of substrates, the major axis direction of the liquid crystal molecule is changed toward the direction of normal of the plane of the substrate and the state of the twisted alignment is resolved.

Linear polarizer plates having polarization axes that are perpendicular to each other are provided on the pair of substrates. The rubbing direction of the orientation film is set along the direction of the polarization axis of the polarizer plate on the corresponding substrate. Because of this structure, when no voltage is applied, linearly polarized light entering the liquid crystal layer through a polarizer plate on the side of the substrate placed near a light source becomes, in the liquid crystal layer which is aligned with the twist of 90°, linearly polarized light having the polarization axis different by 90°. The converted linearly polarized light transmits through the polarizer plate which allows transmission of only linearly polarized light having the polarization axis at a direction 90° different from that of the polarizer plate at the side of entrance of the light. Thus, the light from the light source transmits through the LCD and “white” is displayed. When, on the other hand, a voltage is applied between the electrodes so that the twisted alignment of the liquid crystal is completely resolved and the liquid crystal molecules are aligned with the direction of normal of the plane of the substrate, the linearly polarized light entering the liquid crystal layer from the side near the light source reaches the polarizer plate provided on the other substrate without a change in the polarization in the liquid crystal layer, and, thus, the polarization does not match the polarization axis of the linearly polarized light of the polarizer plate on the emission side, the light cannot transmit through the polarizer plate on the emission side, and “black” is displayed. Gray scales are expressed by adjusting the amount of light which can transmit through the polarizer plate at the emission side through application, to the liquid crystal layer, of a voltage which does not completely resolve the twisted alignment of the liquid crystal layer to convert a portion of the linearly polarized light entering the liquid crystal layer to the linearly polarized light having the polarization axis which is 90° different.

An LCD which uses a vertically aligned (VA) liquid crystal (hereinafter simply referred to as “VA liquid crystal”) is also known. In the VA liquid crystal, the liquid crystal has, for example, a negative dielectric constant anisotropy and the major axis of the liquid crystal molecule is directed along a vertical direction (direction of normal of the plane of the substrate) when no voltage is applied because of a vertical orientation film. In an LCD which uses the VA liquid crystal, polarizer plates having polarization axes different from each other by 90° are provided on the pair of substrates. When no voltage is applied, linearly polarized light entering the liquid crystal layer through the polarizer plate on the side of the substrate placed near the light source reaches the polarizer plate on the substrate on the viewing side without a change in the polarization state because the liquid crystal is vertically aligned and birefringence does not occur in the liquid crystal layer. Thus, the light cannot transmit through the polarizer plate on the viewing side and “black” is displayed. When a voltage is applied between the electrodes, the VA liquid crystal changes so that the major axis of the molecule is tilted towards the direction of plane of the substrate. Because the VA liquid crystal has a negative optical anisotropy (index of refraction anisotropy), the minor axis of the liquid crystal molecule is tilted toward the direction of normal of the plane of the substrate and the linearly polarized light entering the liquid crystal layer from the side of the light source is changed by birefringence in the liquid crystal layer so that the linearly polarized light becomes elliptically polarized as the light transmits through the liquid crystal layer. The elliptically polarized light further becomes circularly polarized light, elliptically polarized light, or linearly polarized light (all of the polarized light has the polarization axis 90° different from the linearly polarized light which enters the liquid crystal). Because of this configuration, when all of the entering linearly polarized light becomes linearly polarized light which is different by 90° by birefringence in the liquid crystal layer, all of the linearly polarized light transmits through the polarizer plate on the substrate on the viewing side, and the display becomes “white (maximum brightness)”. The amount of birefringence is determined by a degree of tilt of the liquid crystal molecule. Therefore, depending on the amount of birefringence, the entering linearly polarized light becomes elliptically polarized light having the same polarization axis, circularly polarize light having the same polarization axis, or elliptically polarized light having polarization axis which differs by 90°, the transmittance of the polarizer plate on the emission side is determined by the polarization state, and a display of a gray scale is obtained.

As described, the LCD is a light valve which adjusts the amount of transmitted light and, normally, the display color depends on the color of the light source. Therefore, when a color display is to be realized using an LCD, a white light source is employed and a color filter is placed in each pixel so that only light of that color transmits through. In general, color filters of three colors of red (R), green (G), and blue (B) are provided, the pixels are associated with these colors, and color display is realized by adjusting the amount of transmitted light for each color in each pixel. In this structure, it is preferable that the relationship between a voltage to be applied to the liquid crystal and the amount of transmitted light in the pixel is identical among the pixels associated with the colors of R, G, and B in order to realize accurate color through a simple control process. However, when a characteristic of the liquid crystal has a wavelength dependency and the pixels associated with different colors have the same structure, display in accurate color cannot be realized by a simple control.

The amount of transmitted light is determined by the amount of birefringence in the liquid crystal layer which is represented by Δn·d/λ when a change in the index of refraction per unit thickness of the liquid crystal layer is Δn, a thickness of the liquid crystal layer (cell gap of LCD) is d, and a wavelength of the transmitted light is λ. Therefore, the amount of birefringence can be equated among pixels associated with different colors by changing the thickness d of the liquid crystal layer according to the wavelength λ and the relationship between the voltage and the amount of transmitted light can be matched. More specifically, the thicknesses of the color filters placed on one of the opposing surfaces of the substrates are set to different thicknesses for different colors to achieve different thicknesses for the liquid crystal layer between the substrates. In the pixels for R having the longest wavelength among the R, G, and B, the thickness of the filter is set to be thin and the thickness of the liquid crystal layer is set to be thick. In the pixels for B having the shortest wavelength among the R, G, and B, on the other hand, the thickness of the filter is set to be thick and the thickness of the liquid crystal layer is set to be thin. Japanese Patent Laid-Open Publication No. 2003-5213 discloses an LCD having different thicknesses of color filters among different colors.

As described, the thickness of the liquid crystal layer affects the amount of transmitted light (brightness) in that pixel and the display quality of the LCD can be improved by maintaining the thickness of the liquid crystal layer at a predetermined value. Therefore, the distance between the substrates which sandwiches the liquid crystal layer must be maintained at an appropriate value and, in some cases, spacers are provided within the display screen at a predetermined density. When the thickness of the liquid crystal layer formed between two substrates differs among pixels, if the position of placement of the spacer is determined at random, the spacers would be placed at a portion in which the thickness of the liquid crystal layer is thin and a portion in which the thickness of the liquid crystal layer is thick. When the height is identical among the spacers, a gap would be created, in the portion in which the liquid crystal layer is thick, between the spacer and the substrate, and, thus, the spacer does not contribute to defining the distance between the substrates and is wasted. In addition, because the alignment of the liquid crystal molecules is disturbed around the spacer, it is preferable to not have wasteful spacers.

### SUMMARY OF THE INVENTION

The present invention advantageously provides a desirable placement of spacers for maintaining the thickness of the liquid crystal layer.

According to one aspect of the present invention, there is provided a liquid crystal display device which has a liquid crystal layer provided between a first substrate having a first electrode and a second substrate having a second electrode, has a plurality of pixels in a display region, and is capable of displaying in a plurality of colors, wherein a thickness of the liquid crystal layer differs depending on a location in the display region, and a spacer which maintains the thickness of the liquid crystal layer between the first substrate and the second substrate is formed on a side of one of the first substrate and the second substrate facing the liquid crystal layer in at least two positions in the display region having thicknesses of the liquid crystal layer that differ from each other.

According to another aspect of the present invention, there is provided a liquid crystal display device which has a liquid crystal layer provided between a first substrate having a first electrode and a second substrate having a second electrode, has a plurality of pixels in a display region, and is capable displaying in a plurality of colors, wherein color-associated gap adjusting layers which adjust thicknesses of the liquid crystal layer in the plurality of pixels according to display colors with which the pixels are associated are provided on a side of one of the first substrate and the second substrate facing the liquid crystal layer, each of the plurality of pixels comprises a transmissive region in which display is realized by allowing light to transmit and a reflective region in which display is realized by reflecting light, a reflective region gap adjusting layer which adjusts the thickness of the liquid crystal layer is formed above the color-associated gap adjusting layer in the reflective region, a spacer which maintains the thickness of the liquid crystal layer between the first substrate and the second substrate is formed above the reflective region gap adjusting layer in at least two positions in the display region which are associated with different display colors and have thicknesses of the liquid crystal layer that differ from each other heights of the spacers are set to values so that a total of a thickness of the color-associated gap adjusting layer and a thickness of the reflective region gap adjusting layer in a pixel in which the spacer is formed is approximately equal in the pixels in which the spacers are formed, and a distance between a position of a surface of the substrate on which the spacer is formed and an upper end surface of the spacer is equal in the pixel regions in which the spacers are formed.

In this manner, because the height of the spacer is optimized in the pixel regions having different thicknesses of the liquid crystal layer depending on the display color or the like and the heights of the spacer differ from each other corresponding to the thicknesses of the liquid crystal layer, the position of the upper end surface of the spacer provided above the substrate in a standing manner is equal in all pixel regions. Because of this structure, the spacer can function to maintain the gap between the substrates, that is, the thickness of the liquid crystal layer in all pixel regions in which the spacers are formed. In other words, all spacers which are formed can effectively function.

### BRIEF DESCRIPTION OF THE DRAWINGS

A preferred embodiment of the present invention will be described in detail by reference to the drawings, wherein:

FIG. 1 is a diagram schematically showing a cross section of an LCD according to a preferred embodiment of the present invention; and

FIG. 2 is a plan view schematically showing an LCD of FIG. 1.

### DESCRIPTION OF THE PREFERRED EMBODIMENTS

Preferred embodiments of the present invention will now be described referring to the drawings.

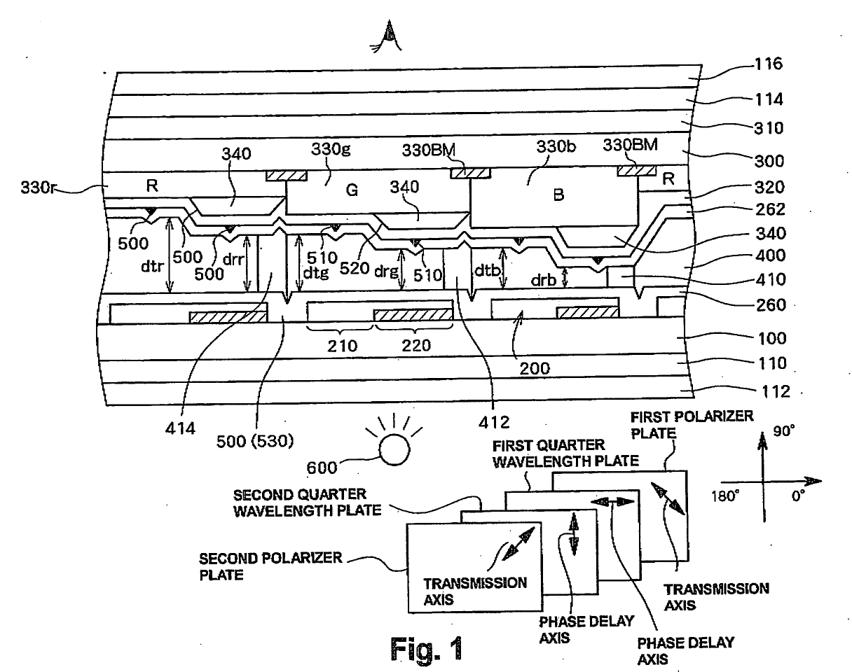

FIG. 1 schematically shows a cross sectional structure when a transflective active matrix LCD is used as an LCD according to a preferred embodiment of the present invention. The drawings including FIG. 1 show the elements schematically in order to allow understanding of the structure of the embodiment and the dimensions in the drawings differ from those of the actual device. In the transflective LCD according to the present embodiment, a first substrate 100 and a second substrate 300 on which a first electrode 200 and a second electrode 320 are formed respectively on the opposing surfaces are adhered with a predetermined gap therebetween and a liquid crystal layer 400 is seal ed in the gap between the substrate. A plurality of pixels are placed in a display region in a matrix form and a transmissive region 210 and a reflective region 220 are formed in each pixel region.

Vertical alignment type liquid crystal having a negative dielectric constant anisotropy is employed as the liquid crystal layer 400 and an orientation controller (orientation divider) 500 for dividing a pixel region into a plurality of alignment regions having different alignment of liquid crystal is provided on one or both of the second substrate and the first substrate. The orientation controller 500 may be formed in a form of, for example, a projection 510 projecting toward the liquid crystal layer 400, a slope section 520, or as an electrode absent portion formed by a gap between pixel electrodes 200 as shown in FIG. 1 (details will be described later).

A transparent substrate such as glass is used as the first substrate 100 and the second substrate 300. A plurality of pixel electrodes 200 in which a transparent conductive metal oxide such as an ITO (Indium Tin Oxide) and IZO (Indium Zinc Oxide) are formed in an individual pattern for each pixel on the side of the first substrate 100 as first electrodes in a matrix form. A thin film transistor (TFT; not shown) is formed between the first substrate 100 and the pixel electrode 200 as a switching element for applying a voltage to the pixel electrode 200 corresponding to the display content. The TFT is electrically connected to the pixel electrode 200. A vertical alignment type orientation film 260 is formed over the entire surface of the first substrate 100 covering the pixel electrode 200. For example, polyimide is used as the orientation film 260. In the present embodiment, a rubbing-less type orientation film is employed and the initial alignment of the liquid crystal (alignment when no voltage is applied) is controlled to a direction perpendicular to the direction of plane of the film. In the present embodiment, a transmissive region 210 and a reflective region 220 are provided within a pixel region as a structure for realizing a transflective liquid crystal display device. In the example structure of FIG. 1, in the transmissive region 210, only the transparent electrode is provided in a formation region of the pixel electrode 200 (corresponds to a pixel region), and, in the reflective region 220, a reflective layer is provided in the formation region of the pixel electrode 200. The reflective layer may function as an electrode in the reflective region or may function solely as a reflective layer. In addition, in the example structure of FIG. 1, a reflective layer is formed on the side of the first substrate 100 and a transparent electrode which is integrally formed in the pixel region covers the reflective layer. In other words, in the reflective region, the reflective layer and the transparent electrodes are formed in a layered manner.

The second substrate 300 which opposes the first substrate 100 with the liquid crystal layer 400 therebetween has color filters formed on a surface facing the liquid crystal layer. In the present embodiment, three color filters for R (red), G (green), and B (blue) are formed depending on the display color, Color filters 330r, 330g, and 330b corresponding to R, G, and B are formed at pixel positions associated with these colors. At a boundary portion between the color filters 330r, 330g, and 330b, that is, the boundary between pixels, a light blocking layer (here, a black filter) 330BM is provided in order to prevent leakage of light from an adjacent pixel and mixture of colors due to the leakage of light.

As shown in FIG. 1, the thicknesses of the color filters differ from each other depending on the color and, consequently, the thickness of the liquid crystal layer differs among pixels of corresponding colors. In other words, because the thickness of the liquid crystal layer is determined for each display color (wavelength of transmitted light), the wavelength dependency between the voltage applied to the liquid crystal layer and the amount of transmitted light can be compensated by the color filters. Thus, the color filters 330r, 330g, and 330b function as color-associated gap adjusting layers for adjusting a thickness (cell gap) of the liquid crystal layer according to the display color (wavelength of transmitted light).

A reflective region gap adjusting layer 340 is selectively provided above the color filters 330r, 330g, and 330b as described above. The reflective region gap adjusting layer 340 is provided so that the thickness (cell gap) dr of the liquid crystal layer in the reflective region 220 of each pixel is a desired value smaller than the thickness (cell gap) dt of the liquid crystal layer in the transmissive region 210 of the pixel (dr<dt). In the configuration of FIG. 1, the reflective region gap adjusting layer 340 is formed only in the reflective region 220 using an optically transparent material. As described above, the cell gap differs depending on the display color and, in the configuration of FIG. 1, the cell gap in the reflective region and the cell gap in the transmissive region in each pixel are indicated with an index of r, g, or b corresponding to the color attached to the notations of dr and dt described above. For example, the cell gap in the reflective region of the pixel for R is represented as drr and the cell gap in the transmissive region of the pixel for R is represented as dtr. The reflective region gap adjusting layer 340 is provided in order to compensate for a difference in the effective cell gap (thickness of the liquid crystal layer) with respect to the exiting light between the transmissive region 210 in which the entering light transmits through the liquid crystal layer 400 once and the reflective region 220 in which the entering light transmits through the liquid crystal layer 400 twice. The thickness of the adjusting layer 340 is determined according to a difference in the thickness d of the liquid crystal layer required for obtaining optimum transmittance and optimum reflectance in the transmissive region 210 and the reflective region 220, respectively. For example, the thickness d of the liquid crystal layer is determined so that an optimum transmittance is obtained in the transmissive region 210 in which no reflective region gap adjusting layer 340 is provided and the reflective region gap adjusting layer 340 is formed in a desired thickness in the reflective region 220 to obtain a thickness d of the liquid crystal layer which is smaller than that for the transmissive region 210.

An electrode 320 which is common to all pixels (common electrode) is formed as a second electrode covering the entire surface of the second substrate 300 including the reflective region gap adjusting layer 340. Similar to the pixel electrode 200, the common electrode 320 may be formed using a transparent conductive metal oxide such as ITO and IZO.

In the present embodiment, a projection 510 is formed as an orientation controller 500 for dividing the alignment direction of the liquid crystal within a pixel region to form a plurality of regions having different alignment directions above the common electrode 320. The projection 510 projects toward the liquid crystal layer 400 and may be insulating or conducting. In the illustrated configuration, the projection 510 can be formed by forming an insulating material, for example, an acrylic resin in a predetermined pattern. The projection 510 is formed both in the transmissive region 210 and the reflective region 220 in the pixel region.

A vertical alignment type rubbing-less orientation film 262 which is similar to that on the side of the first substrate is formed covering the projection 510 and the common electrode 320. As described, the orientation film 262 sets the alignment of the liquid crystal to a direction perpendicular to the plane of the film. However, in a position covering the projection 510, a sloped surface reflecting the shape of the projection 510 is formed. Therefore, at the formation position of the projection 510, the liquid crystal is aligned in a direction perpendicular to the tilted surface of the orientation film covering the projection 510 and the alignment direction of the liquid crystal is divided with the boundary at the projection 510. In the present embodiment, a side surface of the reflective region gap adjusting layer 340 provided on the side of the second substrate 300 is formed in a tapered shape with a tilted surface so that a tilted surface is formed in the orientation film 262 covering the tapered side surface. Thus, the liquid crystal is controlled in a direction perpendicular to the tilted surface and the tilted surface also functions as the orientation controller 500.

In the transflective LCD shown in FIG. 1, a linear polarizer plate (first polarizer plate) 112 and a wide wavelength band quarter wavelength plate (first quarter wavelength plate) 110 having a combination of a quarter wavelength phase difference plate and a half wavelength phase difference plate are provided on an external side of the first substrate 100 (side near the light source 600).

A phase difference plate 310 having a negative index of refraction anisotropy as an optical compensation plate, a wide wavelength band quarter wavelength plate (second quarter wavelength plate) 114 having a combination of a quarter wavelength phase difference plate and a half wavelength phase difference plate, and a linear polarizer plate (second polarizer plate) 116 are provided at an external side of the second substrate 300 (viewing side). For example, as shown at a lower portion of FIG. 1, an axis of the first polarizer plate is set at an angle of 45°, a phase delay axis of the first quarter wavelength plate is set at 90°, a phase delay axis of the second quarter wavelength plate is set at 180°, and an axis of the second polarizer plate is set at 135°.

Light emitted from the light source 600 transmits through the linear polarizer plate 112 at the side of the first substrate 100 and has linear polarization in a direction along the polarization axis of the polarizer plate 112. The linearly polarized light becomes circularly polarized light when the phase difference is shifted by λ/4 at the first quarter wavelength plate 110. In the present embodiment, in order to at least reliably make all components of R, G, and B having different wavelengths to be circularly polarized light to improve the usage efficiency (transmittance) of light in the liquid crystal cell, a wide wavelength band quarter wavelength plate is employed as the first quarter wavelength plate 110 using both a quarter wavelength phase difference plate and a half wavelength phase difference plate. The obtained circularly polarized light transmits through the pixel electrode 200 at the transmissive region 210 and enters the liquid crystal layer 400.

In the transflective LCD according to the present embodiment, as described above, vertical alignment type liquid crystal having a negative dielectric constant anisotropy (Δε<0) is used in the liquid crystal layer 400 and vertical alignment type orientation films 260 and 262 are used.

Therefore, when no voltage is applied, the liquid crystal is aligned along the direction of normal of a plane formed by the orientation films 260 and 262. As the applied voltage is increased, the direction of the major axis of the liquid crystal is tilted toward a perpendicular direction with respect to an electric field formed between the pixel electrode 200 and the common electrode 320 (direction parallel to direction of plane of the substrate) When no voltage is applied to the liquid crystal layer,400, the polarization state is unchanged in the liquid crystal layer 400, and the light reaches the second substrate 300 in the form of circularly polarized light and becomes linearly polarized light at the second quarter wavelength plate 114 in which the circular polarization is resolved. Because the second polarizer plate 116 is placed perpendicular to the direction of linear polarization of the second quarter wavelength plate 116, the linearly polarized light cannot transmit through the second polarizer plate 116 having a transmission axis (polarization axis) perpendicular to that of the first polarizer plate 112. Thus, display becomes black.

When a voltage is applied to the liquid crystal layer 400, the liquid crystal layer 400 creates a phase difference with respect to the entering circularly polarized light and the entering light becomes, for example, circularly polarized light in opposite orientation, elliptically polarized light, or linearly polarized light. When the phase of the obtained light is further shifted by the second quarter wavelength plate 114 by a phase of λ/4, the light becomes linearly polarized light (parallel to transmission axis of the second polarizer plate), elliptically polarized light, or circularly polarized light. Because these polarizations have a component along the polarization axis of the second polarizer plate 116, light in an amount corresponding to this component is emitted through the second polarizer plate 116 to the viewer side and a display of white or gray scale is recognized.

The phase difference plate 310 is a negative retarder and has an opposite optical anisotropy to compensate a slight difference in alignment state of the central region of the liquid crystal layer and the orientation films 260 and 262. When the light transmits through the phase difference plate 310, coloring is resolved, inversion of display or coloring due to unintended pretilt (due to, for example, fixation of the liquid crystal by adsorption near the orientation films 260 and 262) can be resolved, and, as a result, the viewing angle can be improved. Alternatively, it is also possible to use a biaxial phase difference plate having both functions of the negative retarder 310 and the second quarter wavelength plate 114 in place of the retarder 310 and the second quarter wavelength plate 114. With such a structure, the thickness of the LCD can be reduced and the transmittance can be improved.

In the present embodiment, as described above, the thickness (liquid crystal cell gap) d of the liquid crystal layer which substantially controls the transmittance of light is set to be different and desired gaps between the transmissive region 210 and the reflective region 220 using the reflective region gap adjusting layer 340. This is mainly because the display is achieved in the transmissive region 210 by controlling the amount of light (transmittance) transmitting from the light source 600 provided at the backside of the LCD (in the example configuration of FIG. 1, on the side of the first substrate 100), through the liquid crystal layer 400, and emitted to the outside through the second substrate 300 and in the reflective region 220 by controlling an amount of light (reflectance of LCD) entering from the viewing side of the LCD to the liquid crystal layer 400, reflecting by a reflective film or the like provided within a formation region of the pixel electrode 200, again transmitting through the liquid crystal layer 10 400, and emitted to the viewing side through the second substrate 300. Thus, the number of transmissions of the light through the liquid crystal layer differs in the transmissive region 210 and the reflective region 220. More specifically, because the light transmits through the liquid crystal layer 400 twice in the reflective region 220, the cell gap dr of the reflective region 220 must be set smaller than the cell gap dt of the transmissive region 210. In the present embodiment, as shown in FIG. 1, a reflective region gap adjusting layer 340 having a desired thickness is provided only in the reflective region 220 in each pixel region so that the above-described relationships of drr<dtr, drg<dtg, and drb<dtb are achieved. The reflective region gap adjusting layer 340 is not limited as long as the layer 340 allows light to transmit and can be formed in a desired thickness, and, for example, an acrylic resin which is also used for a planarizing insulating layer or the like may be employed for the reflective region gap adjusting layer 340.

In the present embodiment, in addition to the thickness d of the liquid crystal layer being varied between the transmissive region 210 and the reflective region 220 within a pixel region, the thickness of the liquid crystal layer is also varied among according to he wavelength of the color with which each of the pixels for R, G, and B is associated. In the example configuration of FIG. 1, all gaps d for R, G, and B are realized by varying the thicknesses of the color filter 330r for R, color filter 330g for G, and color filter 330b for B formed on the side of the second substrate 300. The present invention is not limited to a configuration in which the thicknesses of the color filters are varied, and, alternatively, it is also possible to employ a configuration in which the thicknesses of the color filters are set common to all colors, a gap adjusting layer similar to the reflective region gap adjusting layer 340 is provided also in the transmissive region 210, and the thicknesses of the gap adjusting layers are varied in the transmissive region 210 and the reflective region 220 for each of R, G, and B. In addition, the present intention is not limited to a configuration in which the thicknesses d of the liquid crystal layer in all of R, G, and B differ from each other, and, alternatively, it is also possible to employ, for example, a configuration in which the thickness of the liquid crystal layer is set equal in the pixels for G and B and the thickness in the pixel for R differs from that of the other two colors or a configuration in which the thickness in the pixel for B differs from the other two colors, depending on the characteristic of the LCD.

In the present embodiment, the thickness d of the liquid crystal layer is maintained at a predetermined thickness by spacers 410, 412, and 414. In other words, the spacers 410, 412, and 414 which define a gap between the first substrate 100 and the second substrate 300 are used. In addition, the spacers 410t 412, and 414 are integrally formed on the substrate in advance. More specifically, each of the spacers 410, 412, and 414 has an approximate circular cylinder shape and are formed in a standing manner above the reflective region gap adjusting layer 340 formed above the color filter in each of the reflective regions 220 of the pixel regions for B, for G, and for R. Although the spacers 410, 412, and 414 are placed in adjacent pixels for G, for B, and for R in FIG. 1, in an actual device, the spacer may be formed in a portion of the plurality of pixels for each display color. The spacers are preferably placed in an approximate uniform density over the entire display region.

The spacers 410, 412, and 414 are formed to heights which are approximately equal to the thicknesses drb, drg, and drr of the liquid crystal layer in the corresponding pixel regions. As described, the thickness of the liquid crystal layer is determined based on the wavelength dependency of the amount of transmitted light and whether the region is a reflective region or a transmissive region. The heights of the spacers are determined so that the thickness of the liquid crystal layer in the corresponding region is a value required for the characteristic. In the present embodiment, spacers having the determined heights are formed in a standing manner above the orientation film 262 covering a region above the color filters 330r, 330g, and 330b formed on a surface of the second substrate 300 facing the liquid crystal layer. As a result of this structure, the upper surface (lower end surface in FIG. 1) of the spacers 410, 412, and 414 are positioned in a surface parallel to and in an equal distance from the second substrate 300 in all pixel regions and contact a surface, of the orientation film 260 which covers the pixel electrode 200 formed on the side of the first substrate 100, facing the liquid crystal layer. In other words, all spacers contribute to define and maintain the thickness of the liquid crystal layer between the first substrate 100 and the second substrate 300.

In other words, the spacers define a gap between the first substrate 100 and the second substrate 300 at a predetermined value along with the color filter (color-associated gap adjusting layer) which adjusts a thickness of the liquid crystal layer for each display color and the reflective region gap adjusting layer which adjusts the thickness of the liquid crystal layer in the reflective region. That is, a value obtained by adding the thickness of the color filter, the thickness of the reflective region gap adjusting layer, and the height of the spacer is a constant value in the pixel regions of all display colors. With this structure, the gap between the two substrates 100 and 300 are reliably maintained at a constant value in each position of the display region. The expression of “above” in the “above the color filter” or the like includes a situation in which one element is positioned above another element in direct contact with each other and situations in which one element is positioned above the other element with another member therebetween. That is, the expression of “above” indicates a state in which two members, for example, a color filter and a spacer are projected on a plane parallel to the substrate and the projected images overlap. In any case, if the spacer is of distributive type, it is difficult to selectively distribute only in the pixel region in which a particular thickness of the liquid crystal layer is to be achieved. Therefore, in the present embodiment, the spacer is integrally formed on one of the substrates of the LCD, in particular, the second substrate (substrate on which common electrode is formed) on which the switching element or the like is not formed.

Although all spacers are placed in the reflective region 220, that is, above the reflective region gap adjusting layer 340 in the structure shown in FIG. 1, the present invention is not limited to such a configuration and all or a portion of the spacers may be formed in the transmissive region 210. In this case, the heights of the spacers are set equal to the gaps dtb, dtg, and dtr in the pixel region in which the spacers are formed. As long as a density of formation of the spacers is sufficient, the spacers does not need to be formed in all pixel regions of the three colors of R, G, and B. For example, the spacers may be formed only in pixel regions for two colors. When the spacer is provided above the transmissive region 210, the height of the spacer is set so that a value (total value) of an addition of the height of the spacer and the thickness of the color-associated gap adjusting layer is a constant value. When the spacer is formed in the transmissive region and in the reflective region, the heights of the spacers are sete so that a total of the height of the spacer and the thickness of the color-associated gap adjusting layer in the transmissive region and a total of the height of the spacer, the thickness of the color-associated gap adjusting layer, and the thickness of the reflective region gap adjusting layer are a constant value. Because of this structure, a position of the upper end surface, of each of the spacers provided in a standing manner above the second substrate 300, which contacts the side of the first substrate 100 is equal in all pixel regions, and, thus, the gap between the first substrate 100 and the second substrate 300 can be reliably maintained at a predetermined value using the spacers.

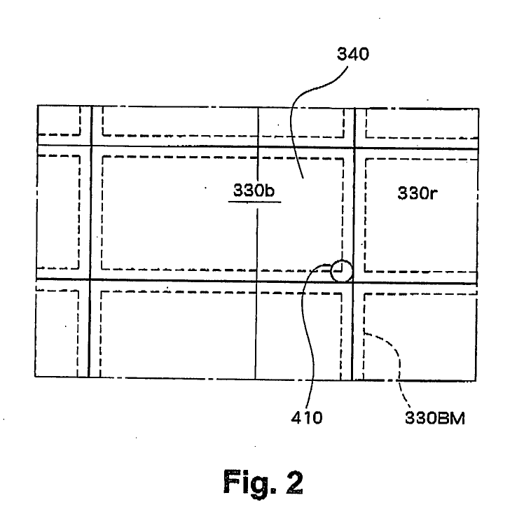

The spacers 410, 412, and 414 are preferably placed so that a portion of the spacer overlaps a light blocking layer 330BM provided at a periphery of a pixel. FIG. 2 is a plan view exemplifying a positional relationship between the light blocking layer 330BM and the spacer 410 and shows the structure of FIG. 1 seen from the below, with the first substrate 100 and accompanying structures omitted. A light blocking layer 330BM is formed between the color filter 330b of the pixel for B and the color filter of an adjacent pixel, that is, in a boundary region between pixel regions. The light blocking layer 330BM is formed in an overall lattice shape, as shown in FIG. 2. The spacer 410 is placed so that at least a portion of the spacer 410 overlaps the formation region of the light blocking layer 330BM. The portion of the light blocking layer 330BM does not contribute to display and it is preferable to place, in this region, the spacer 410 which may disturb the alignment of the liquid crystal in order to secure, in a pixel, a largest possible region in which high display quality can be realized. In particular, in the present embodiment, the spacer 410 is placed near an intersection in the lattice (a vertex portion of a pixel region having an approximate rectangular shape) so that an area in which the formation region of the spacer 410 overlaps the formation region of the light blocking layer 330BM is increased. In addition, by placing the spacer at the furthest edge of the pixel, influences by the spacer 410 on the display are inhibited. When a width of the light blocking layer 330BM is sufficiently large compared to a diameter of the spacer 410, it is preferable that the entire spacer 410 be placed in the region above the light blocking layer 330BM. As already described, the spacers 410, 412, and 414 do not need to be formed in all pixel regions and it is preferable that the number of spacers be reduced within a range for achieving a density of spacers necessary for securing the cell gap. For example, in a panel having a ratio of a horizontal scan direction to a vertical scan direction (horizontal scan direction:vertical scan direction) of 4:3, the necessary cell gap can be secured by forming a spacer 410 every 12 pixels.

The spacer 410 can be formed using a transparent insulating resin such as an acrylic resin. In this case, the spacer is formed through the following method. First, a resin material which is before cured and to which an optical curing property is given is applied, through spin coating, to the second substrate 300 after the color filter, orientation film, etc. are formed on the second substrate 300. Then, a predetermined portion is selectively irradiated with light using a mask For the like to cure the irradiated portion and the portion which is not cured is removed. Alternatively, it is also possible to form the spacer 410 by applying, on the orientation film 260, the acrylic resin in a form of paste to which a photosensitive material is mixed, exposing the acrylic resin to leave the spacer formation region, removing the acrylic resin from the region other than the spacer formation region, and curing the resin selectively left in the spacer formation region through calcination or the like.

Because a viscosity of the resin material for the spacer is relatively high, when the spacer material is applied on the orientation film 262 through spin coating, an upper surface of the resin (front surface) of the resin layer reflects the unevenness of the lower layers and is not a completely flat surface and the height of the upper surface of the resin layer differs among the pixel regions by an amount corresponding to the thicknesses of the color filters, reflective region gap adjusting layers, etc. In other words, the resin layer has the same thickness in all pixel regions. In the present embodiment, spacers having different heights are formed in the pixel regions in which different cell gaps are to be set according to the display color.

For this purpose, the spacers 412 and 414 to be formed to different heights than that of the spacer 410 are formed in separate processes. That is, after the spacer 410 is formed, the spacer 412 is formed through a formation process similar to that of the spacer 410 and the spacer 414 is then formed.

Differences among the heights of the spacers in the pixel regions of the display colors can be realized by, for example, adjusting an amount of the resin to be supplied during spin coating, that is, the thickness of the resin layer corresponding to the desired height. Alternatively, it is also possible to employ a method in which, when the spacer 410 which has the lowest height is formed, the resin layer is formed also in the formation regions of the spacers 412 and 414, a resin layer having a thickness corresponding to a difference between, for example, the desired heights-of the spacer 412 and the spacer 410 is applied, and the resin layer is selectively left only in the formation region of the spacer 412 or also in the formation region of the spacer 414. In this manner, a resin layer for forming the spacer 412 is layered on the resin layer having the height of the spacer 410 such that the spacer 412 is formed with the total height of these layers being the desired height. The spacer 414 can be formed by forming a resin layer on the resin layer having the height of the spacer 410 to a height corresponding to a difference between the heights of the spacer 410 and the spacer 414 or layering a resin layer on the resin layer having the height of the spacer 412 to a height corresponding to a difference between the heights of the spacer 412 and the spacer 414.

Formation of the spacers 410, 412, and 414 to different heights may alternatively be realized by adjusting the irradiation period of light, irradiation intensity of light, etc. For example, a resin having a photosensitive material is used as the resin for forming the spacer and the resin is applied through spin coating to a thickness corresponding to the spacer 414 having the highest required height in advance. Then, the applied resin layer is exposed using a halftone mask having an amount of opening corresponding to the height of the spacer to be formed. By exposing the resin layer using the halftone mask, it is possible to determine the amount of exposure based on the required height, that is, the amount of spacer resin layer to be left on the substrate. Therefore, by using a desired etching solution after the exposure process for development, it is possible to simultaneously form the spacers 410, 412, and 414 having thicknesses different from each other in the pixel regions for the display colors.

As described, in the present embodiment, by forming the spacers 410, 412, and 414 having heights corresponding to the thicknesses of the liquid crystal layer in the regions having different required thickness of the liquid crystal layer, it is possible to easily and reliably maintain the thickness of the liquid crystal layer to a desired value at any location in the display region.

An embodiment of VA liquid crystal has been described. The present invention, however, is not limited to such a configuration and may be applied to the TN liquid crystal,

What is claimed is:

1. A liquid crystal display device which has a liquid crystal layer provided between a first substrate having a first electrode and a second substrate having a second electrode, has a plurality of pixels in a display region, and is capable of displaying in a plurality of colors, wherein
a thickness of the liquid crystal layer differs depending on a location in the display region, and
a spacer which maintains the thickness of the liquid crystal layer between the first substrate and the second substrate is formed on a side of one of the first substrate and the second substrate facing the liquid crystal layer in at least two positions in the display region having thicknesses of the liquid crystal layer that differ from each other.

2. A liquid crystal display device according to claim 1, wherein
color-associated gap adjusting layers which adjust the thicknesses of the liquid crystal layer in the plurality of pixels according to display colors with which the pixels are associated are provided on a side of one of the first substrate and the second substrate facing the liquid crystal layer, and
heights of the spacers are set to values so that a total of the height of the spacer and a thickness of the color-associated gap adjusting layer of the pixel in which the spacer is formed is approximately equal in the pixels in which the spacers are provided.

3. A liquid crystal display device according to claim 2, wherein
the color-associated gap adjusting layer is a color filter corresponding to the display color with which the pixel is associated.

4. A liquid crystal display device according to claim 3, wherein
the color filters are provided for displaying red, for displaying green, and for displaying blue.

5. A liquid crystal display device according to claim 1, wherein
each of the plurality of pixels comprises a transmissive region in which display is realized by allowing light to transmit and a reflective region in which display is realized by reflecting light,
in the reflective region, a reflective region gap adjusting layer which adjusts the thickness of the liquid crystal layer is formed on a side of one of the first substrate and the second substrate facing the liquid crystal layer,
the spacer is formed above the reflective region gap adjusting layer, and
heights of the spacers are set to values so that a total of the height of the spacer and a thickness of the reflective region gap adjusting layer in a pixel in which the spacer is formed is approximately equal in the pixels in which the spacers are formed.

6. A liquid crystal display device according to claim 1, wherein
color-associated gap adjusting layers which adjust the thicknesses of the liquid crystal layer in the plurality of pixels according to display colors with which the pixels are associated are provided on a side of one of the first substrate and the second substrate facing the liquid crystal layer,
each of the plurality of pixels comprises a transmissive region in which display is realized by allowing light to transmit and a reflective region in which display is realized by reflecting light,
a reflective region gap adjusting layer which adjusts the thickness of the liquid crystal layer is formed above the color-associated gap adjusting layer in the reflective region,
the spacer is formed above the reflective region gap adjusting layer, and
heights of the spacers are set to values so that a total of a thickness of the color-associated gap adjusting layer and a thickness of the reflective region gap adjusting layer in a pixel in which the spacer is formed is approximately equal in the pixels in which the spacers are provided.

7. A liquid crystal display device according to claim 6, wherein
the color-associated gap adjusting layer is a color filter corresponding to the display color with which the pixel is associated.

8. A liquid crystal display device according to claim 7, wherein
the color filters are provided for displaying red, for displaying green, and for displaying blue.

9. A liquid crystal display device according to claim 1, wherein
a light blocking layer which prevents leakage of light from an adjacent pixel is provided in a boundary between pixel regions, and
at least a portion of a formation region of the spacer overlaps a formation region of the light blocking layer.

10. A liquid crystal display device according to claim 1, wherein
liquid crystal in the liquid crystal layer is vertical alignment type liquid crystal.

11. A liquid crystal display device which has a liquid crystal layer provided between a first substrate having a first electrode and a second substrate having a second electrode, has a plurality of pixels in a display region, and is capable of displaying in a plurality of colors, wherein
color-associated gap adjusting layers which adjust thicknesses of the liquid crystal layer in the plurality of pixels according to display colors with which the pixels are associated are provided on a side of one of the first substrate and the second substrate facing the liquid crystal layer,
each of the plurality of pixels comprises a transmissive region in which display is realized by allowing light to transmit and a reflective region in which display is realized by reflecting light,
a reflective region gap adjusting layer which adjusts the thickness of the liquid crystal layer is formed above the color-associated gap adjusting layer in the reflective region;
a spacer which maintains the thickness of the liquid crystal layer between the first substrate and the second substrate is formed above the reflective region gap adjusting layer in at least two positions in the display region which are associated with different display colors and have thicknesses of the liquid crystal layer that differ from each other,
heights of the spacers are set to values so that a total of a thickness of the color-associated gap adjusting layer and a thickness of the reflective region gap adjusting layer in a pixel in which the spacer is formed is approximately equal in the pixels in which the spacers are formed, and
a distance between a position of a surface of the substrate on which the spacer is formed and an upper end surface of the spacer is equal in the pixel regions in which the spacers are formed.

12. A liquid crystal display device according to claim 11, wherein
the color filters are provided for displaying red, for displaying green, and for displaying blue.

13. A liquid crystal display device according to claim 11, wherein
a light blocking layer which prevents leakage of light from an adjacent pixel is provided in a boundary between pixel regions, and
at least a portion of a formation region of the spacer overlaps a formation region of the light blocking layer.

14. A liquid crystal display device according to claim 11, wherein
liquid crystal in the liquid crystal layer is vertical alignment type liquid crystal,
